(19) United States
(12) Patent Application Publication
(10) Pub. No.: US 2025/0391198 A1
(43) Pub. Date: Dec. 25, 2025

(54) FINGERPRINT INFORMATION PROCESSING APPARATUS, FINGERPRINT INFORMATION PROCESSING METHOD, AND RECORDING MEDIUM

(71) Applicant: NEC Corporation, Minato-ku, Tokyo (JP)

(72) Inventor: Akira HIROKAWA, Tokyo (JP)

(73) Assignee: NEC Corporation, Minato-ku, Tokyo (JP)

(21) Appl. No.: 18/860,047

(22) PCT Filed: Jul. 3, 2023
(86) PCT No.: PCT/JP2023/024572

§ 371 Date: Aug. 4, 2025

(30) Foreign Application Priority Data
Jul. 28, 2022 (JP) 2022-120344

(51) Int. Cl. G06V 40/12; G06V 10/82

(52) U.S. Cl. CPC G06V 40/1376; G06V 10/82

(57) ABSTRACT

A fingerprint information processing apparatus includes: an output unit that outputs a certainty factor that is an index indicating probability in which fingerprints indicated by a fingerprint image correspond to at least one of a plurality of pattern types, by using the fingerprint image and a learning model constructed by machine learning using learning data including a sample image indicating fingerprints; and a processing unit that performs processing based on the certainty factor.

### TECHNICAL FIELD

This disclosure relates to technical fields of a fingerprint information processing apparatus, a fingerprint information processing method, and a recording medium.

### BACKGROUND ART

For example, there is proposed an apparatus that generates a ridge direction pattern from a fingerprint image and that classifies fingerprints from shapes of ridges near a core of the ridge direction pattern and tendency of a ridge direction (see Patent Literature 1). Furthermore, prior art documents related to this disclosure include Patent Literatures 2 and 3.

### CITATION LIST

### Patent Literature

Patent Literature 1: JPH06-139338A
Patent Literature 2: JPH09-161054A
Patent Literature 3: International Publication No. WO2012/090287

### SUMMARY

### Technical Problem

It is an example object of this disclosure to provide a fingerprint information processing apparatus, a fingerprint information processing method, and a recording medium that aim to improve the techniques/technologies disclosed in Citation List.

### Solution to Problem

A fingerprint information processing apparatus according to an example aspect of this disclosure includes: an output unit that outputs a certainty factor that is an index indicating probability in which fingerprints indicated by a fingerprint image correspond to at least one of a plurality of pattern types, by using the fingerprint image and a learning model constructed by machine learning using learning data including a sample image indicating fingerprints; and a processing unit that performs processing based on the certainty factor.

A fingerprint information processing method according to an example aspect of this disclosure includes: outputting a certainty factor that is an index indicating probability in which fingerprints indicated by a fingerprint image correspond to at least one of a plurality of pattern types, by using the fingerprint image and a learning model constructed by machine learning using learning data including a sample image indicating fingerprints; and performing processing based on the certainty factor.

A recording medium according to an example aspect of this disclosure is a recording medium on which a computer program that allows a computer to execute a fingerprint information processing method is recorded, the fingerprint information processing method including: outputting a certainty factor that is an index indicating probability in which fingerprints indicated by a fingerprint image correspond to at least one of a plurality of pattern types, by using the fingerprint image and a learning model constructed by machine learning using learning data including a sample image indicating fingerprints; and performing processing based on the certainty factor.

### BRIEF DESCRIPTION OF DRAWINGS

FIG. 1 is a block diagram illustrating an example of a configuration of an information processing apparatus.

FIG. 2 is a block diagram illustrating another example of the configuration of the information processing apparatus.

FIG. 3 is a diagram illustrating an example of an output image.

FIG. 4 is a diagram illustrating another example of the output image.

FIG. 5 is a flowchart illustrating operation according to a second example embodiment.

FIG. 6 is a flowchart illustrating operation according to a third example embodiment.

FIG. 7 is a flowchart illustrating operation according to a fourth example embodiment.

FIG. 8 is a flowchart illustrating operation according to a fifth example embodiment.

FIG. 9 is a flowchart illustrating operation according to a sixth example embodiment.

FIG. 10 is a flowchart illustrating operation according to a seventh example embodiment.

FIG. 11 is a flowchart illustrating operation according to an eighth example embodiment.

### DESCRIPTION OF EXAMPLE EMBODIMENTS

Hereinafter, a fingerprint information processing apparatus, a fingerprint information processing method, and a recording medium according to example embodiments will be described with reference to the drawings.

### First Example Embodiment

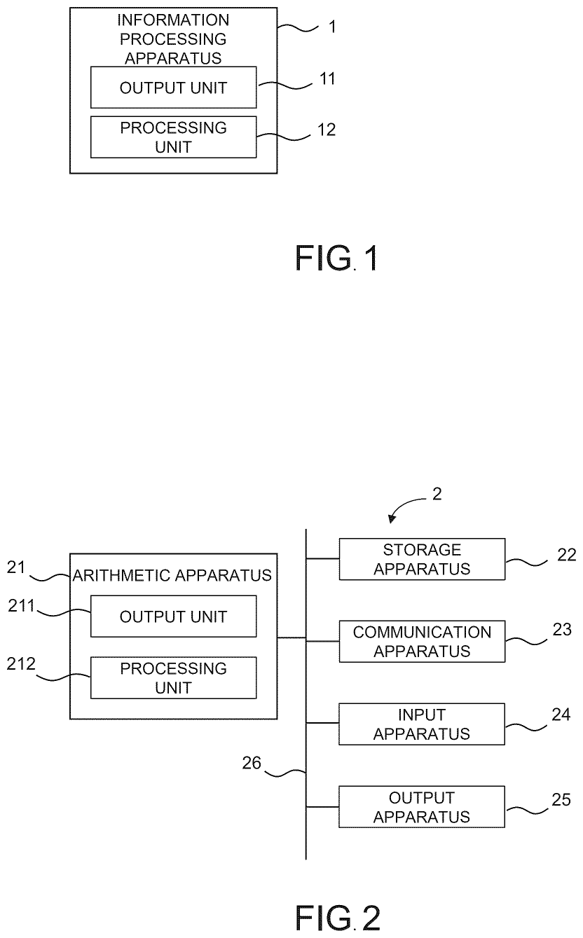

A fingerprint information processing apparatus, a fingerprint information processing method, and a recording medium according to a first example embodiment will be described with reference to FIG. 1. The following describes the fingerprint information processing apparatus, the fingerprint information processing method, and the recording medium according to the first example embodiment, by using an information processing apparatus 1. FIG. 1 is a block diagram illustrating a configuration of the information processing apparatus 1.

As illustrated in FIG. 1, the information processing apparatus 1 includes an output unit 11 and a processing unit 12. The output unit 11 outputs a certainty factor/a confidence factor that is an index indicating probability in which fingerprints indicated by a fingerprint image correspond to at least one of a plurality of pattern types, by using the fingerprint image and a learning model constructed by machine learning using learning data including a sample image indicating fingerprints. The processing unit 12 performs processing based on the certainty factor.

In the information processing apparatus 1, first, the output unit 11 may output the certainty factor, by using the fingerprint image and the learning model. The processing unit 12 may then perform the processing based on the certainty factor. That is, the information processing apparatus 1 may output the certainty factor and may perform the processing based on the certainty factor, by using the fingerprint image and the learning model. Such an information processing apparatus 1 may be realized or implemented, for example, by a computer reading a computer program recorded on a recording medium. In this case, it can be said that a computer program that allows a computer to execute the processing based on the certainty factor is recorded on a recording medium, the processing including: outputting the certainty factor by using the fingerprint image and the learning model.

The fingerprint image may include, for example, an image generated by detecting fingerprints with a sensor, and an image generated by imaging stamped fingerprints or residual fingerprints with a camera or reading them with a scanner. For the sensor for detecting fingerprints, a contact sensor of an optical type, a capacitive type, of an ultrasonic type, or the like, or a non-contact sensor such as OCT (Optical Coherence Tomography and a three-dimensional fingerprint scanner, can be applied, for example. The pattern type means a collection of patterns that are formed by ridges of a fingertip (i.e., fingerprints) and that have a common shape based on shapes of the ridges, ridge flow directions, or the like, for example. The pattern type may include, for example, an arch pattern, a loop pattern, a whorl pattern, and the like.

Various existing aspects can be applied to a method of constructing the learning model by the machine learning using the learning data including the sample image indicating fingerprints. Therefore, a detailed description of the method of constructing the learning model will be omitted. The learning model may be constructed by deep learning that is an aspect of the machine learning. The learning model constructed by deep learning may mean a mathematical model constructed by machine learning using a multilayer neural network in which there are multiple intermediate layers (which may be referred to as hidden layers). The neural network may be, for example, a convolutional neural network. For a model structure according to the convolutional neural network, a VGG, MobileNet, or the like may be used, for example.

The certainty factor is an index indicating probability in which fingerprints correspond to at least one of the plurality of pattern types. As the possibility that fingerprints correspond to one pattern type is higher, the certainty factor may be higher. In other words, the possibility that fingerprints correspond to one pattern type is lower, the certainty factor may be lower. The certainty factor may be expressed by a numerical value, or may be expressed by a grade or a rank, such as A, B, and so on, for example. The certainty factor may be referred to as probability.

The output unit 11 may obtain the certainty factor for one of the plurality of pattern types by using the fingerprint image and the learning model, and may output the obtained certainty factor, for example. The output unit 11 may obtain a plurality of certainty factors respectively corresponding to the plurality of pattern types by using the fingerprint image and the learning model, and may output the highest one of the plurality of certainty factors obtained, for example. The output unit 11 may obtain the plurality of certainty factors respectively corresponding to the plurality of pattern types by using the fingerprint image and the learning model, and may output one or a plurality of certainty factors that is higher than a predetermined value, out of the plurality of certainty factors obtained, for example. The output unit 11 may obtain the plurality of certainty factors respectively corresponding to the plurality of pattern types by using the fingerprint image and the learning model, and may output all the plurality of certainty factors obtained, for example. The output unit 11 may output the certainty factor, for example, to a display apparatus. In this case, the certainty factor outputted from the output unit 11 may be displayed on a screen of the display apparatus.

The processing unit 12 performs the processing based on the certainty factor outputted from the output unit 11. The “processing based on the certainty factor” may include processing based directly on the certainty factor and processing based indirectly on the certainty factor.

The processing based on the certainty factor may include processing of estimating the pattern type to which the fingerprints indicated by the fingerprint image correspond, from the plurality of pattern types, on the basis of the certainty factor, for example. The processing based indirectly on the certainty factor may include processing of limiting a verification target on the basis of the pattern type to which the fingerprints indicated by the fingerprint image estimated on the basis of the certainty factor correspond, and of collating/verifying the fingerprints indicated by the fingerprint image, for example.

According to the first example embodiment, it is possible to improve the prior art.

### Second Example Embodiment

A fingerprint information processing apparatus, a fingerprint information processing method, and a recording medium according to a second example embodiment will be described with reference to FIG. 2 to FIG. 5. The following describes the fingerprint information processing apparatus, the fingerprint information processing method, and the recording medium according to the second example embodiment, by using an information processing apparatus 2. FIG. 2 is a block diagram illustrating a configuration of the information processing apparatus 2.

As illustrated in FIG. 2, the information processing apparatus 2 includes an arithmetic apparatus 21 and a storage apparatus 22. The information processing apparatus 2 may include a communication apparatus 23, an input apparatus 24, and an output apparatus 25. The information processing apparatus 2 may not include at least one of the communication apparatus 23, the input apparatus 24, and the output apparatus 25. In the information processing apparatus 2, the arithmetic apparatus 21, the storage apparatus 22, the communication apparatus 23, the input apparatus 24, and the output apparatus 25 may be connected through a data bus 26.

The arithmetic apparatus 21 may include, for example, at least one of a CPU (Central Processing Unit), a GPU (Graphics Processing Unit), and a FPGA (Field Programmable Gate Array).

The storage apparatus 22 may include, for example, at least one of a RAM (Random Access Memory), a ROM (Read Only Memory), a hard disk apparatus, a magneto-optical disk apparatus, a SSD (Solid State Drive), and an optical disk array. That is, the storage apparatus 22 may include a non-transitory recording medium. The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program.

The communication apparatus 23 may be configured to communicate with an apparatus external to the information processing apparatus 2 through a not-illustrated communication network. The communication network may be a wide area network such as, for example, the Internet, or may be a narrow area network such as, for example, a LAN (Local Area Network). The communication apparatus 23 may perform wired communication or may perform wireless communication.

The input apparatus 24 is an apparatus that is configured to receive an input of information to the information processing apparatus 2 from the outside. For example, the input apparatus 24 may include an operating apparatus (e.g., at least one of a keyboard, a mouse, and a touch panel) that is operable by an operator of the information processing apparatus 2. The input apparatus 24 may include a recording medium reading apparatus that is configured to read information recorded on a recording medium that is attachable to the information processing apparatus 2, such as a USB (Universal Serial Bus) memory. When information is inputted to the information processing apparatus 2 through the communication apparatus 23 (in other words, when the information processing apparatus 2 acquires information through the communication apparatus 23), the communication apparatus 23 may function as an input apparatus.

The output apparatus 25 is an apparatus that is configured to output information to the outside of the information processing apparatus 2. The output apparatus 25 may output visual information such as characters and an image, may output auditory information such as a voice/sound, or may output tactile information such as vibration, as the information described above. The output apparatus 25 may include, for example, at least one of a display, a speaker, a printer, and a vibration motor. The output apparatus 25 may be configured to output information to a recording medium that is attachable to and detachable from the information processing apparatus 2, such as, for example, a USB memory. When the information processing apparatus 2 outputs information through the communication apparatus 23, the communication apparatus 23 may function as an output apparatus.

The arithmetic apparatus 21 may include an output unit 211 and a processing unit 212, for example, as functional blocks that are logically realized or implemented, or as processing circuits that are physically realized or implemented. At least one of the output unit 211 and the processing unit 212 may be realized or implemented in mixed formats of the logical functional blocks and the physical processing circuits (i.e., hardware). When at least a part of the output unit 211 and the processing unit 212 is the functional block, at least the part of the output unit 211 and the processing unit 212 may be realized or implemented by the arithmetic apparatus 21 executing a predetermined computer program.

The arithmetic apparatus 21 may acquire (in other words, may read) the predetermined computer program, for example, from the storage apparatus 22. The arithmetic apparatus 21 may read the predetermined computer program stored by a computer-readable and non-transitory recording medium, by using a not-illustrated recording medium reading apparatus provided in the information processing apparatus 2, for example. The arithmetic apparatus 21 may acquire (in other words, may downloaded or may read) the predetermined computer program from a not-illustrated apparatus disposed outside the information processing apparatus 2, through the communication apparatus 23. For the recording medium on which the predetermined computer program to be executed by the arithmetic apparatus 21 is recorded, at least one of an optical disk, a magnetic medium, a magneto-optical disk, a semiconductor memory, and any other medium that is configured to store a program may be used.

The output unit 211 includes the learning model constructed by the machine learning using the learning data including the sample image indicating fingerprints. The output unit 211 acquires the certainty factor from the learning model by inputting the fingerprint image to the learning model. The certainty factor is an index indicating probability in which the fingerprints indicated by the fingerprint image correspond to at least one of the plurality of pattern types. Therefore, the output unit 211 may acquire the certainty factor in association with the pattern type.

The input apparatus 24 may include a sensor that is configured to detect fingerprints, for example. The fingerprint image may be generated by the sensor detecting fingerprints. The output unit 211 may acquire the generated fingerprint image. The input apparatus 24 may include, for example, a scanner. The fingerprint image may be generated by reading stamped fingerprints or residual fingerprints with the scanner. The output unit 211 may acquire the generated fingerprint image. The input apparatus 24 may include an image acquisition apparatus that is configured to acquire an image captured by a camera, for example. The fingerprint image may be generated by the camera imaging stamped fingerprints or residual fingerprints. The output unit 211 may acquire the fingerprint image through the image acquisition apparatus included in the input apparatus 24.

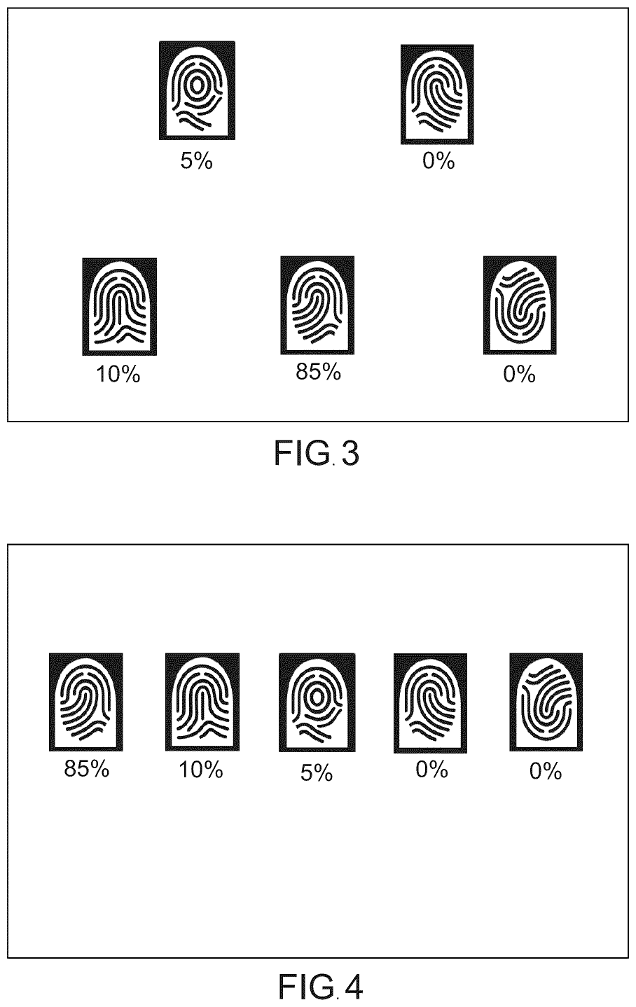

The output unit 211 transmits (outputs) a signal indicating the certainty factor to the processing unit 212. In this instance, the output unit 211 may transmit a signal indicating the certainty factor and the pattern type associated with the certainty factor, to the processing unit 212. The output unit 211 may transmit, for example, the signal indicating the certainty factor and the pattern type associated with the certainty factor, for example, to the output apparatus 25. In this case, the output apparatus 25 may display (in other words, may output) at least one of characters and an image indicating at least one pattern type, and at least one of characters and an image indicating the certainty factor associated with the at least one pattern type, for example. Consequently, an image as illustrated in FIG. 3 may be displayed.

The processing unit 212 performs the processing based on the certainty factor. For example, when the signal indicating the certainty factor and the pattern type associated with the certainty factor is transmitted from the output unit 211 to each of the processing unit 212 and the output apparatus 25, the processing unit 212 may determine order of the pattern types on the basis of the certainty factor, for example. The processing unit 212 may transmit a signal indicating the determined order of the pattern types, to the output apparatus 25. In this case, the output apparatus 25 may indicate at least one of the characters and the image indicating the pattern type, and at least one of the characters and the image indicating the certainty factor associated with the pattern type, in accordance with the determined order of the pattern types. Consequently, an image as illustrated in FIG. 4 may be displayed.

For example, when the signal indicating the certainty factor and the pattern type associated with the certainty factor is transmitted from the output unit 211 to the processing unit 212, the processing unit 212 may compare the certainty factor with a first predetermined value. Here, it is assumed that the certainty factor is expressed by a numerical value. When the certainty factor is higher than the first predetermined value, the processing unit 212 may associate the pattern type associated with the certainty factor that is higher than the first predetermined value, with the fingerprint image. In other words, the processing unit 212 may classify the fingerprints indicated by the fingerprint image, into the pattern type associated with the certainty factor that is higher than the first predetermined value. When there is no pattern type associated with the certainty factor that is higher than the first predetermined value, the processing unit 212 may classify the fingerprints indicated by the fingerprint image, into an incomplete pattern, for example.

When the plurality of certainty factors respectively associated with the plurality of pattern types are higher than the first predetermined value, the processing unit 212 may associate the plurality of pattern types with the fingerprint image. In this instance, the processing unit 212 may set the pattern type associated with the highest certainty factor, to a main pattern (i.e., a main pattern type). The processing unit 212 may set the pattern types corresponding to certainty factors, excluding the highest one of the plurality of certainty factors that are higher than the first predetermined value, to a sub-pattern (i.e., an auxiliary pattern type).

The “first predetermined value” is a value for determining whether or not the fingerprint image can be associated with one pattern type, in other words, whether or not the fingerprints indicated by the fingerprint image can be classified into one pattern type. The first predetermined value may be a fixed value set in advance, or may be a variable value according to some physical quantity or parameters. The first predetermined value may be set as follows. For example, the certainty factor of each pattern type outputted from the output unit 211 for one fingerprint image may be associated with a judging result obtained from a fingerprint appraiser who judges the fingerprints indicated by the one fingerprint image. This processing may be performed on a plurality of fingerprint images. The first predetermined value may be set on the basis of a distribution of the certainty factors in which the pattern type associated with the highest certainty factor matches the pattern type indicated by the judging result.

The processing unit 212 may transmit a signal indicating the fingerprint image and the pattern type associated with the fingerprint image, to an apparatus that is configured to perform fingerprint verification and that is different from the information processing apparatus 2, through the communication apparatus 23, for example. For example, when the storage apparatus 22 includes a fingerprint database, the processing unit 212 may perform fingerprint verification by using the fingerprint database. Various existing aspects can be applied to the fingerprint verification. Therefore, a detailed description of the fingerprint verification will be omitted, but an outline thereof will be described below.

In the fingerprint database, the pattern types may be respectively associated with the plurality of fingerprint images. In addition, various existing aspects can be applied to this association method. For example, it includes a method of generating or updating table information indicating a correlation between the fingerprint image and the pattern type. For example, it also includes a method of adding data indicating the pattern type to headers of image data about the fingerprint image.

The processing unit 212 may extract the fingerprint image to be verified with one fingerprint image, from the fingerprint database, on the basis of the pattern type associated with the one fingerprint image. As a consequence, the fingerprint image associated with the same pattern type as the pattern type associated with the one fingerprint image, is extracted from the fingerprint database as a verification target of the one fingerprint image. On the other hand, the fingerprint image associated with a different pattern type from the pattern type associated with the one fingerprint image, may not be extracted from the fingerprint database as the verification target of the one fingerprint image. When the one fingerprint image is associated with the pattern type serving as the main pattern and the pattern type serving as the sub-pattern, the fingerprint image associated with the same pattern type as the pattern type serving as the main pattern, and the fingerprint image associated with the same pattern type as the pattern type serving as the sub-pattern, may be extracted from the fingerprint database. The processing unit 212 may compare a plurality of feature points relating to the fingerprints indicated by the one fingerprint image, with a plurality of feature points relating to the fingerprints indicated by the fingerprint image that is the verification target, thereby collating/verifying both the fingerprints. The processing unit 212 may determine that both the fingerprints match when a part of the plurality of feature points (e.g., 12 feature points) matches between both the fingerprints.

The processing unit 212 may store the fingerprint image and the pattern type associated with the fingerprint image, in the storage apparatus 22 in association with each other, for example. As a result, for example, the fingerprint database may be constructed or updated. The processing unit 212 may also store the certainty factor associated with the pattern type associated with the fingerprint image, in the storage apparatus, in association with the fingerprint image. The processing unit 212 may transmit the signal indicating the fingerprint image and the pattern type associated with the fingerprint image, to an apparatus that manages the fingerprint database and that is different from the information processing apparatus 2, through the communication apparatus 23, for example. As a result, the fingerprint database may be updated.

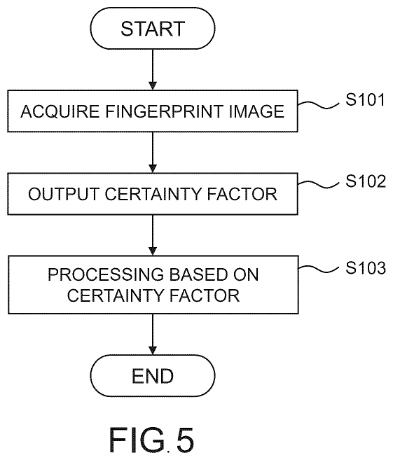

With reference to a flowchart in FIG. 5, operation of the information processing apparatus 2 will be described. In FIG. 5, the output unit 211 of the arithmetic apparatus 21 acquires the fingerprint image (step S101). The output unit 211 outputs the certainty factor by using the fingerprint image and the learning model. (step S102). The processing unit 212 of the arithmetic apparatus 21 performs the processing based on the certainty factor (step S103).

The above operation may be realized by the information processing apparatus 2 reading a computer program recorded on a recording medium. In this case, it can be said that a computer program that allows the information processing apparatus 2 to perform the above operation is recorded on a recording medium. The arithmetic apparatus 21 of the information processing apparatus 2 may correspond to the information processing apparatus 1 according to the first example embodiment.

According to the second example embodiment, it is possible to improve the prior art.

### Third Example Embodiment

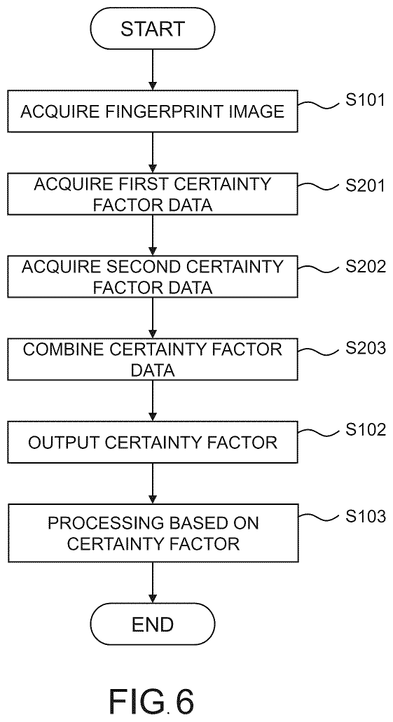

A fingerprint information processing apparatus, a fingerprint information processing method, and a recording medium according to a third example embodiment will be described with reference to FIG. 2 and FIG. 6. The following describes the fingerprint information processing apparatus, the fingerprint information processing method, and the recording medium according to the third example embodiment, by using the information processing apparatus 2. The third example embodiment is different from the second example embodiment, in that the output unit 211 of the arithmetic apparatus 21 includes a plurality of learning models. Other points according to the third example embodiment may be the same as those of the second example embodiment.

The output unit 211 may include a first model and a second model, each of which is constructed by the machine learning using the learning data including the sample image indicating fingerprints, for example. That is, the output unit 211 may include the first model and the second model, as the learning model in the second example embodiment. The output unit 211 may include three or more learning models.

Here, the first model and the second model are learning models having different output tendencies to an input. The first model and the second model may be constructed, for example, by setting different numbers of the intermediate layers that constitute the neural network. The first model and the second model may be constructed, for example, by setting different numbers of nodes included in the intermediate layers that constitute the neural network. The first model and the second model may be constructed, for example, by setting different model structures relating to the neural network. The first model and the second model may be constructed, for example, by setting different learning data used for the machine learning of the neural network.

The output unit 211 acquires first certainty factor data indicating the certainty factor that is an output result of the first model, by inputting one fingerprint image to the first model. The output unit 211 acquires second certainty factor data indicating the certainty factor that is an output result of the second model, by inputting the one fingerprint image to the second model. The first certainty factor data and the second certainty factor data are data indicating the plurality of certainty factors respectively corresponding to the plurality of pattern types. In the third example embodiment, the certainty factor is assumed to be expressed by a numerical value.

The output unit 211 combines the first certainty factor data with the second certainty factor data. Specifically, the output unit 211 combines the plurality of certainty factors respectively corresponding to the plurality of pattern types indicated by each of the first certainty factor data and the second certainty factor data, for each pattern type. In this case, the output unit 211 may combine the certainty factor corresponding to one pattern type indicated by the first certainty factor data, with the certainty factor corresponding to the one pattern type indicated by the second certainty factor data, and may obtain a combined value of the certainty factors corresponding to the one pattern type. The “combined value of the certainty factors” may be, for example, an average/mean value or an addition value. In the case of obtaining the combined value of the certainty factors, for example, the output tendency to the input may be used as a weight of the combination, in each of the first model and the second model. For example, it is assumed that detection accuracy of a right loop pattern in the first model is better than that of a right loop pattern in the second model, and that detection accuracy of a left loop pattern in the second model is better than that of a left loop pattern in the first model. For example, when the combined value of the certainty factors is obtained for the right loop pattern, the certainty factors may be combined by setting a weight of the certainty factor corresponding to the right loop pattern indicated by the first certainty factor data to be larger than a weight of the certainty factor corresponding to the right loop pattern indicated by the second certainty factor data. Similarly, when the combined value of the certainty factors is obtained for the left loop pattern, the certainty factors may be combined by setting a weight of the certainty factor corresponding to the left loop pattern indicated by the second certainty factor data to be larger than a weight of the certainty factor corresponding to the left loop pattern indicated by the first certainty factor data.

By combining the first certainty factor data and the second certainty factor data, third certainty factor data indicating the certainty factor after the combination for each pattern type are generated. The output unit 211 transmits a signal indicating the certainty factor after the combination, to the processing unit 212 on the basis of the third certainty factor data.

With reference to a flowchart in FIG. 6, the operation of the information processing apparatus 2 will be described. In FIG. 6, the output unit 211 of the arithmetic apparatus 21 acquires the fingerprint image (step S101). The output unit 211 acquires the first certainty factor data by inputting the fingerprint image to the first model (step S201). The output unit 211 acquires the second certainty factor data by inputting the fingerprint image to the second model, in parallel with the step S201 (step S202). The output unit 211 may perform the step S202 on the condition that the first certainty factor data are acquired in the step S201. In other words, the output unit 211 may acquire the second certainty factor data after acquiring the first certainty factor data. Alternatively, the output unit 211 may acquire the first certainty factor data after acquiring the second certainty factor data. The output unit 211 combines the first certainty factor data with the second certainty factor data (step S203). The output unit 211 outputs the certainty factor after the combination indicated by the third certainty factor data generated by combining the first certainty factor data with the second certainty factor data (step S102). The processing unit 212 of the arithmetic apparatus 21 performs the processing based on the certainty factor (step S103).

The above operation may be realized by the information processing apparatus 2 reading a computer program recorded on a recording medium. In this case, it can be said that a computer program that allows the information processing apparatus 2 to perform the above operation is recorded on a recording medium.

According to the third example embodiment, it is possible to improve the accuracy of the certainty factor outputted from the output unit 211.

### Fourth Example Embodiment

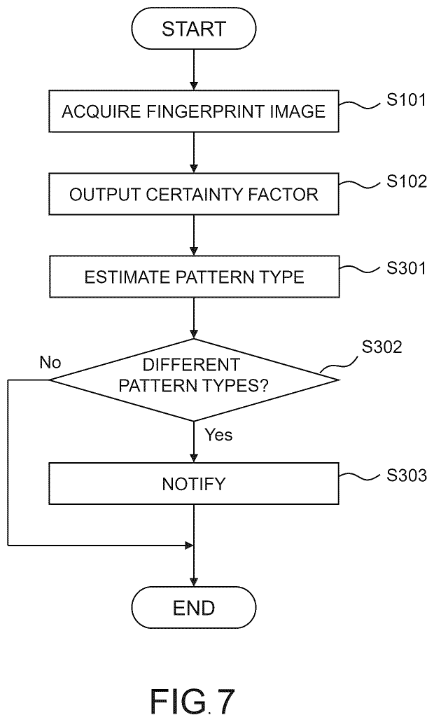

A fingerprint information processing apparatus, a fingerprint information processing method, and a recording medium according to a fourth example embodiment will be described with reference to FIG. 2 and FIG. 7. The following describes the fingerprint information processing apparatus, the fingerprint information processing method, and the recording medium according to the fourth example embodiment, by using the information processing apparatus 2. Here describes an example in which the information processing apparatus 2 is applied to a review work of the existing fingerprint database. The fourth example embodiment mainly describes processing performed by the processing unit 212 (i.e., the processing based on the certainty factor). Other points according to the fourth example embodiment may be the same as those of the second and third example embodiments.

In the fingerprint database, fingerprints are often classified and registered in accordance with the pattern type. In other words, in the fingerprint database, the fingerprint image indicating fingerprints is often associated with the pattern type to which the fingerprints are classified. This is for efficient fingerprint verification, for example. Specifically, it is possible to limit (i.e., reduce) the verification target by limiting a search range of the fingerprint database on the basis of the pattern type.

For example, fingerprint data collected over decades may be accumulated in the fingerprint database managed by a public institution. Traditionally, the pattern type of fingerprints is often determined on a rule basis (i.e., in accordance with rules described by humans). On the rule basis, it is possible to determine the pattern type of fingerprints with relatively high accuracy, if it corresponds to the rules. On the other hand, it is hardly possible to identify the pattern type of fingerprints, from the viewpoint that it is hardly described as rules. Therefore, for example, when fingerprints can be interpreted in a plurality of pattern types, the fingerprints may be classified into a wrong pattern type. For example, in the fingerprint verification in which the search range of the fingerprint database is limited on the basis of the pattern type, the fingerprints classified in the wrong pattern type may be leaked from the verification target.

If the learning model constructed by deep learning is used as the learning model in the second and third example embodiments, it is expected that it is possible to identify the pattern type of fingerprints that takes into account the viewpoint that it is hardly described as rules, for example. Therefore, the existing fingerprint database may be reviewed by a method described below.

The information processing apparatus 2 may perform the following operation to support the review work of reviewing the fingerprint database, for example. The output unit 211 of the arithmetic apparatus 21 acquires one fingerprint image registered in the fingerprint database. The output unit 211 acquires the certainty factor relating to the one fingerprint image, by inputting the one fingerprint image to the learning model constructed by deep learning. In this instance, the output unit 211 may acquire the plurality of certainty factors respectively corresponding to the plurality of pattern types, for the one fingerprint image. The output unit 211 transmits a signal indicating the certainty factor relating to the one fingerprint image, to the processing unit 212 of the arithmetic apparatus 21.

The processing unit 212 compares the certainty factor relating to the one fingerprint image, with the first predetermined value (see the second example embodiment). The processing unit 212 estimates the pattern type of the fingerprints indicated by the one fingerprint image, on the basis of a comparison result between each of the plurality of certainty factors respectively corresponding to the plurality of pattern types and the first predetermined value.

For the one fingerprint image, when the certainty factor that is higher than the first predetermined value is included in the plurality of certainty factors respectively corresponding to the plurality of pattern types, the processing unit 212 estimates that the pattern type of the fingerprints indicated by the one fingerprint image is the pattern type corresponding to the certainty factor that is higher than the first predetermined value. In this instance, the processing unit 212 associates the one fingerprint image with the pattern type corresponding to the certainty factor that is higher than the first predetermined value. When the plurality of certainty factors respectively associated with the plurality of pattern types are higher than the first predetermined value, the processing unit 212 may associate the one fingerprint image with the plurality of pattern types.

When the certainty factor that is higher than the first predetermined value is not included in the plurality of certainty factors respectively corresponding to the plurality of pattern types, the processing unit 212 may estimate that the pattern type of the fingerprints indicated by the one fingerprint image is an incomplete pattern. In this instance, the processing unit 212 may associate the one fingerprint image with the incomplete pattern as the pattern type.

The processing unit 212 determines whether or not the pattern type associated with the one fingerprint image in the fingerprint database is the same as the pattern type associated with the one fingerprint image on the basis of the certainty factor. When the pattern type associated with the one fingerprint image in the fingerprint database is different from the pattern type associated with the one fingerprint image on the basis of the certainty factor, the processing unit 212 gives notice to encourage a user to review the pattern type.

As the notice, the processing unit 212 may send an e-mail to a manager/administrator of the fingerprint database, to encourage the manager to review the pattern type, for example. As the notice, the processing unit 212 may display the fingerprint image in which the pattern type associated with the one fingerprint image in the fingerprint database is different from the pattern type associated with the one fingerprint image on the basis of the certainty factor, for example. A notification method is not limited to these, and various existing aspects can be applied thereto.

In a case where the pattern type associated with the one fingerprint image in the finger database is different from the pattern type associated with the one fingerprint image on the basis of the certainty factor, the processing unit 212 may give notice to encourage the user to review the pattern type when the certainty factor corresponding to the pattern type associated with the one fingerprint image on the basis of the certainty factor is higher than a second predetermined value.

The “second predetermined value” is a value for determining whether or not the user is notified that the pattern types are different. The second predetermined value may be a fixed value set in advance, or may be a variable value according to some physical quantity or parameters. The second predetermined value may be set as follows. For example, when the pattern type associated with the one fingerprint image in the finger database is different from the pattern type associated with the one fingerprint image on the basis of the certainty factor, a relation between the certainty factor and fingerprints in which the pattern type is corrected by a fingerprint expert, may be obtained. The second predetermined value may be set on the basis of the obtained relation.

With reference to a flowchart in FIG. 7, the operation of the information processing apparatus 2 will be described. In FIG. 7, the output unit 211 of the arithmetic apparatus 21 acquires one fingerprint image from the fingerprint database (step S101). The output unit 211 acquires the certainty factor relating to the one fingerprint image, by inputting the one fingerprint image to the learning model constructed by deep learning. The output unit 211 outputs the certainty factor relating to the one fingerprint image (step S102).

The processing unit 212 of the arithmetic apparatus 21 compares each of the plurality of certainty factors respectively corresponding to the plurality of pattern types, with the first predetermined value, on the basis of the certainty factor relating to the one fingerprint image. The processing unit 212 estimates the pattern type of the fingerprints indicated by the one fingerprint image, on the basis of the comparison result between each of the plurality of certainty factors respectively corresponding to the plurality of pattern types and the first predetermined value (step S301).

In the step S301, for the one fingerprint image, when the certainty factor that is higher than the first predetermined value is included in the plurality of certainty factors respectively corresponding to the plurality of pattern types, the processing unit 212 estimates that the pattern type of the fingerprints indicated by the one fingerprint image is the pattern type corresponding to the certainty factor that is higher than the first predetermined value. In this instance, the processing unit 212 associates the one fingerprint image with the pattern type corresponding to the certainty factor that is higher than the first predetermined value. When the plurality of certainty factors respectively associated with the plurality of pattern types are higher than the first predetermined value, the processing unit 212 may associate the one fingerprint image with the plurality of pattern types. When the certainty factor that is higher than the first predetermined value is not included in the plurality of certainty factors respectively corresponding to the plurality of pattern types, the processing unit 212 may estimate that the pattern type of the fingerprints indicated by the one fingerprint image is an incomplete pattern. In this instance, the processing unit 212 may associate the one fingerprint image with the incomplete pattern as the pattern type.

The processing unit 212 determines whether or not the pattern type associated with the one fingerprint image in the fingerprint database is different from the pattern type associated with the one fingerprint image on the basis of the certainty factor (i.e., the pattern type associated with the one fingerprint image in the step S301) (step S302). In the step S302, when it is determined that the pattern type associated with the one fingerprint image in the fingerprint database is the same as the pattern type associated with the one fingerprint image on the basis of the certainty factor (the step S302: No), the operation illustrated in FIG. 7 is ended.

In the step S302, when it is determined that the pattern type associated with the one fingerprint image in the fingerprint database is different from the pattern type associated with the one fingerprint image on the basis of the certainty factor (the step S302: Yes), the processing unit 212 gives notice to encourage the user to review the pattern type (step S303).

In the step S302, when it is determined that the pattern type associated with the one fingerprint image in the fingerprint database is different from the pattern type associated with the one fingerprint image on the basis of the certainty factor (the step S302: Yes), the processing unit 212 may determine whether or not the certainty factor corresponding to the pattern type associated with the one fingerprint image on the basis of the certain factor is higher than the second predetermined value. When it is determined that the certainty factor is higher than the second predetermined value, the processing unit 212 may give notice to encourage the user to review the pattern type. On the other hand, when it is determined that the certainty factor is lower than the second predetermined value, the processing unit 212 may not give notice to encourage the user to review the pattern type. A case where the certainty factor is equal to the second predetermined value, may be included and treated in one of the two cases.

The above operation may be realized by the information processing apparatus 2 reading a computer program recorded on a recording medium. In this case, it can be said that a computer program that allows the information processing apparatus 2 to perform the above operation is recorded on a recording medium.

According to the fourth example embodiment, it is possible to detect the fingerprints that may be classified into a wrong pattern type, out of the plurality of fingerprints registered in the fingerprint database.

### First Modified Example

The processing unit 212 may replace the pattern type associated with the one fingerprint image in the fingerprint database, with the pattern type associated with the one fingerprint image on the basis of the certainty factor, instead of giving notice to encourage the user to review the pattern type, for example. That is, in the step S302, when it is determined that the pattern type associated with the one fingerprint image in the fingerprint database is different from the pattern type associated with the one fingerprint image on the basis of the certainty factor (the step S302: Yes), the processing unit 212 may replace the pattern type associated with the one fingerprint image in the fingerprint database, with the pattern type associated with the one fingerprint image on the basis of the certainty factor. In this instance, the processing unit 212 may notify the user that the pattern type is replaced. The replacement of the pattern type associated with the one fingerprint image in the fingerprint database, may be considered equivalent to updating the pattern type associated with the one fingerprint image in the fingerprint database.

### Second Modified Example

Alternatively, the processing unit 212 may register the pattern type associated with the one fingerprint image on the basis of the certainty factor, in the fingerprint database, as the sub-pattern relating to the one fingerprint image, instead of giving notice to encourage the user to review the pattern type, for example. That is, in the step S302, when it is determined that the pattern type associated with the one fingerprint image in the fingerprint database is different from the pattern type associated with the one fingerprint image on the basis of the certainty factor (the step S302: Yes), the processing unit 212 may associate the pattern type associated with the one fingerprint image on the basis of the certainty factor, with the one fingerprint image, as the sub-pattern relating to the one fingerprint image. In this instance, the processing unit 212 may notify the user that the sub-pattern is registered. The registration of the sub-pattern relating to the one fingerprint image in the fingerprint database, may be considered equivalent to updating the pattern type associated with the one fingerprint image in the fingerprint database.

### Fifth Example Embodiment

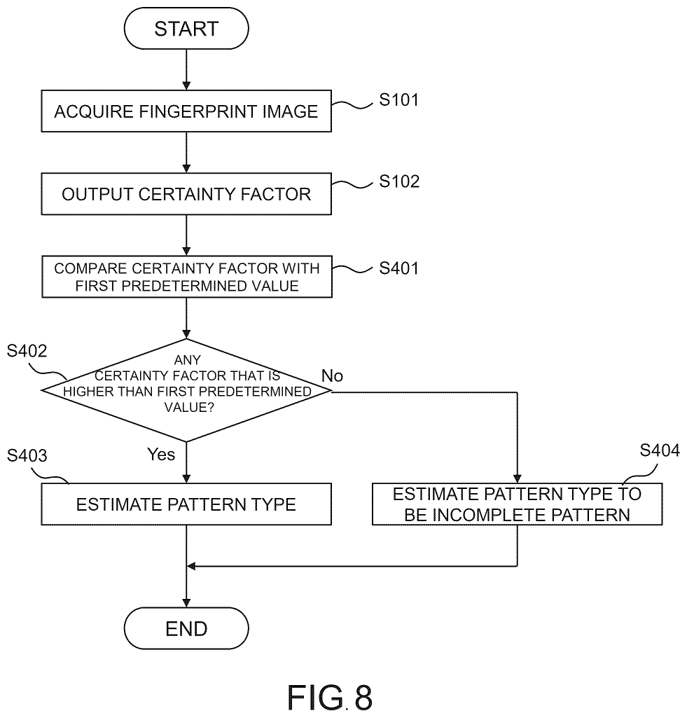

A fingerprint information processing apparatus, a fingerprint information processing method, and a recording medium according to a fifth example embodiment will be described with reference to FIG. 2 and FIG. 8. The following describes the fingerprint information processing apparatus, the fingerprint information processing method, and the recording medium according to the fifth example embodiment, by using the information processing apparatus 2. Here describes an example in which the information processing apparatus 2 is applied to a fingerprint registration work. The fifth example embodiment mainly describes processing performed by the processing unit 212 (i.e., the processing based on the certainty factor). Other points according to the fifth example embodiment may be the same as those of the second to fourth example embodiments.

Fingerprints are often classified by an expert/person with special knowledge such as a fingerprint expert. Therefore, an organization without an expert, often requests another organization with an expert to classify fingerprints indicated by a newly collected fingerprint image. In such a case, the one organization may not be able to register the newly collected fingerprint image in the fingerprint database until a fingerprint classification work by the other organization is completed. Therefore, the fingerprint classification may be performed in the one organization by the techniques described below.

The information processing apparatus 2 may perform the following operation to support the fingerprint registering operation, for example. Here, it is assumed that the information processing apparatus 2 is provided in the one organization described above.

The output unit 211 of the arithmetic apparatus 21 acquires one fingerprint image as the newly collected fingerprint image. The output unit 211 acquires the certainty factor of the one fingerprint image by inputting the one fingerprint image to the learning model. In this instance, the output unit 211 may acquire the plurality of certainty factors respectively corresponding to the plurality of pattern types, for the one fingerprint image. The output unit 211 transmits a signal indicating the certainty factor relating to the one fingerprint image, to the processing unit 212 of the arithmetic apparatus 21.

The processing unit 212 compares the certainty factor relating to the one fingerprint image, with the first predetermined value (see the second example embodiment). The processing unit 212 estimates the pattern type of the fingerprints indicated by the one fingerprint image, on the basis of the comparison result between each of the plurality of certainty factors respectively corresponding to the plurality of pattern types and the first predetermined value.

For the one fingerprint image, when the certainty factor that is higher than the first predetermined value is included in the plurality of certainty factors respectively corresponding to the plurality of pattern types, the processing unit 212 estimates that the pattern type of the fingerprints indicated by the one fingerprint image is the pattern type corresponding to the certainty factor that is higher than the first predetermined value. In this instance, the processing unit 212 associates the one fingerprint image with the pattern type corresponding to the certainty factor that is higher than the first predetermined value. When the plurality of certainty factors respectively associated with the plurality of pattern types are higher than the first predetermined value, the processing unit 212 may associate the one fingerprint image with the plurality of pattern types.

When the certainty factor that is higher than the first predetermined value is not included in the plurality of certainty factors respectively corresponding to the plurality of pattern types, the processing unit 212 may estimate that the pattern type of the fingerprints indicated by the one fingerprint image is an incomplete pattern. In this instance, the processing unit 212 may associate the one fingerprint image with the incomplete pattern as the pattern type.

The processing unit 212 may transmit a signal indicating the pattern type associated with the one fingerprint image, to the output apparatus 25. That is, the processing unit 212 may transmit a signal indicating the estimated pattern type, to the output apparatus 25. Consequently, at least one of characters and an image indicating the pattern type associated with the one fingerprint image may be displayed.

With reference to a flowchart in FIG. 8, the operation of the information processing apparatus 2 will be described. In FIG. 8, the output unit 211 of the arithmetic apparatus 21 acquires one fingerprint image as the newly collected fingerprint image (step S101). The output unit 211 acquires the certainty factor of the one fingerprint image by inputting the one fingerprint image to the learning model. The output unit 211 outputs the certainty factor relating to the one fingerprint image (step S102).

The processing unit 212 of the arithmetic apparatus 21 compares each of the plurality of certainty factors respectively corresponding to the plurality of pattern types, with the first predetermined value, on the basis of the certainty factor relating to the one fingerprint image (step S401). The processing unit 212 determines whether or not the certainty factor that is higher than the first predetermined value is included in the plurality of certainty factors respectively corresponding to the plurality of pattern types, on the basis of the comparison result (step S402). In the step S402, when it is determined that the certainty factor that is higher than the first predetermined value is included (the step S402: Yes), the processing unit 212 estimates that the pattern type of the fingerprints indicated by the one fingerprint image is the pattern type corresponding to the certainty factor that is higher than the first predetermined value (step S403). In this instance, the processing unit 212 associates the one fingerprint image with the pattern type corresponding to the certainty factor that is higher than the first predetermined value. When the plurality of certainty factors respectively associated with the plurality of pattern types are higher than the first predetermined value, the processing unit 212 may associate the one fingerprint image with the plurality of pattern types.

In the step S402, when it is determined that the certainty factor that is higher than the first predetermined value is not included (the step S402: No), the processing unit 212 may estimate that the pattern type of the fingerprints indicated by the one fingerprint image is an incomplete pattern (step S404). In this instance, the processing unit 212 may associate the one fingerprint image with the incomplete pattern as the pattern type.

The above operation may be realized by the information processing apparatus 2 reading a computer program recorded on a recording medium. In this case, it can be said that a computer program that allows the information processing apparatus 2 to perform the above operation is recorded on a recording medium.

According to the fifth example embodiment, the one organization described above is able to perform the fingerprint registration work relatively early, for example, with the information processing apparatus 2 referring to the pattern type of the fingerprints associated with the one fingerprint image, and without requesting another organization to classify fingerprints. Since the fingerprints are registered relatively early, it is possible to collate/verify newly registered fingerprints with previously registered fingerprints, relatively early, for example. For example, when fingerprints registered in the past are associated with various types of information about an individual corresponding to the fingerprints, and when previously registered fingerprints that match newly registered fingerprints are found in the fingerprint verification, it is possible to acquire various types of information about an individual corresponding to the newly registered fingerprints, relatively early.

### Modified Example

The processing unit 212 may register the one fingerprint image and the pattern type associated with the one fingerprint image, in the fingerprint database, in association with each other, after the steps S403 or S404, for example.

### Sixth Example Embodiment

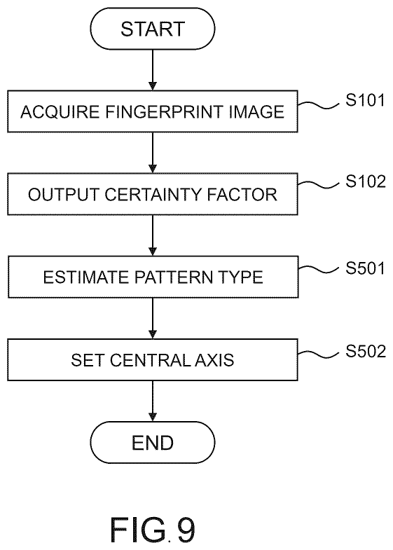

A fingerprint information processing apparatus, a fingerprint information processing method, and a recording medium according to a sixth example embodiment will be described with reference to FIG. 2 and FIG. 9. The following describes the fingerprint information processing apparatus, the fingerprint information processing method, and the recording medium according to the sixth example embodiment, by using the information processing apparatus 2. Here describes an example in which the information processing apparatus 2 is applied to the fingerprint registration work. The sixth example embodiment mainly describes processing performed by the processing unit 212 (i.e., the processing based on the certainty factor). Other points according to the sixth example embodiment may be the same as those of the second to fifth example embodiments.

In the case of residual fingerprints, for example, the ridges may not be clear, or only a part of the fingerprints may remain, or noise may be superimposed on the fingerprints. In order to properly perform the fingerprint verification on the resident fingerprints, a verification range may be limited on the basis of a central axis indicating a center position of the fingerprints. The central axis may be set for all the fingerprints, not just for the resident fingerprints. The central axis may be set, for example, when newly acquired fingerprints are registered.

The “central axis” is an axis passing through the center position (which may be referred to as a center point) of the fingerprints and extending in a particular direction. The particular direction (i.e., a direction in which the central axis extends) is a fingertip direction for the arch pattern serving as the pattern type, and a direction of core recurve for a pattern type other than the arch pattern. The “core recurve” means the innermost loop-shaped ridge of the fingerprints. The center position of the fingerprints may be a position corresponding to a tip of the loop shape represented by the core recurve. The “direction of core recurve” means a front and back direction of the loop shape represented by the core recurve. The direction of core recurve often varies depending on the pattern type. Therefore, the direction in which the central axis extends, often varies depending on the pattern type.

The information processing apparatus 2 may perform the following operation to support the fingerprint registration work, for example.

The output unit 211 of the arithmetic apparatus 21 acquires one fingerprint image as the newly collected fingerprint image. The output unit 211 acquires the certainty factor of the one fingerprint image by inputting the one fingerprint image to the learning model. In this instance, the output unit 211 may acquire the plurality of certainty factors respectively corresponding to the plurality of pattern types, for the one fingerprint image. The output unit 211 transmits a signal indicating the certainty factor relating to the one fingerprint image, to the processing unit 212 of the arithmetic apparatus 21.

The processing unit 212 compares the certainty factor relating to the one fingerprint image, with the first predetermined value (see the second example embodiment). The processing unit 212 estimates the pattern type of the fingerprints indicated by the one fingerprint image, on the basis of the comparison result between each of the plurality of certainty factors respectively corresponding to the plurality of pattern types and the first predetermined value.

For the one fingerprint image, when the certainty factor that is higher than the first predetermined value is included in the plurality of certainty factors respectively corresponding to the plurality of pattern types, the processing unit 212 estimates that the pattern type of the fingerprints indicated by the one fingerprint image is the pattern type corresponding to the certainty factor that is higher than the first predetermined value. In this instance, the processing unit 212 associates the one fingerprint image with the pattern type corresponding to the certainty factor that is higher than the first predetermined value. When the plurality of certainty factors respectively associated with the plurality of pattern types are higher than the first predetermined value, the processing unit 212 may associate the one fingerprint image with the plurality of pattern types.

When the certainty factor that is higher than the first predetermined value is not included in the plurality of certainty factors respectively corresponding to the plurality of pattern types, the processing unit 212 may estimate that the pattern type of the fingerprints indicated by the one fingerprint image is an incomplete pattern. In this instance, the processing unit 212 may associate the one fingerprint image with the incomplete pattern as the pattern type.

The processing unit 212 sets the central axis on the basis of the pattern type associated with the one fingerprint image and the one fingerprint image. When a plurality of pattern types are associated with the one fingerprint image, the processing unit 212 may set a plurality of central axes respectively corresponding to the plurality of pattern types. That is, the processing unit 212 may set one central axis for each pattern type associated with the one fingerprint image. When the one fingerprint image is associated with an incomplete pattern, the processing unit 212 may not set the central axis.

When the arch pattern is associated with the one fingerprint image, the processing portion 212 may set the central axis extending in the fingertip direction. When the pattern type other than the arch pattern is associated with the one fingerprint image, the processing portion 212 may set the central axis extending in the direction of core recurve. Various existing aspects can be applied to a method of identifying the fingertip direction and the direction of core recurve from the fingerprints indicated by the one fingerprint image. Therefore, a detailed description of the method will be omitted.

The processing unit 212 may transmit the pattern type associated with the one fingerprint image and the central axis corresponding to the pattern type, to the output apparatus 25. Consequently, at least one of characters and an image indicating the pattern type associated with the one fingerprint image and the central axis corresponding to the pattern type may be displayed.

With reference to a flowchart in FIG. 9, the operation of the information processing apparatus 2 will be described. In FIG. 9, the output unit 211 of the arithmetic apparatus 21 acquires one fingerprint image as the newly collected fingerprint image (step S101). The output unit 211 acquires the certainty factor relating to the one fingerprint image by inputting the one fingerprint image to the learning model. The output unit 211 outputs the certainty factor relating to the one fingerprint image (step S102).

The processing unit 212 of the arithmetic apparatus 21 compares each of the plurality of certainty factors respectively corresponding to the plurality of pattern types, with the first predetermined value, on the basis of the certainty factor relating to the one fingerprint image. The processing unit 212 estimates the pattern type of the fingerprints indicated by the one fingerprint image, on the basis of the comparison result between each of the plurality of certainty factors respectively corresponding to the plurality of pattern types and the first predetermined value (step S501).

In the step S501, for the one fingerprint image, when the certainty factor that is higher than the first predetermined value is included in the plurality of certainty factors respectively corresponding to the plurality of pattern types, the processing unit 212 estimates that the pattern type of the fingerprints indicated by the one fingerprint image is the pattern type corresponding to the certainty factor that is higher than the first predetermined value. In this instance, the processing unit 212 associates the one fingerprint image with the pattern type corresponding to the certainty factor that is higher than the first predetermined value. When the plurality of certainty factors respectively associated with the plurality of pattern types are higher than the first predetermined value, the processing unit 212 may associate the one fingerprint image with the plurality of pattern types. When the certainty factor that is higher than the first predetermined value is not included in the plurality of certainty factors respectively corresponding to the plurality of pattern types, the processing unit 212 may estimate that the pattern type of the fingerprints indicated by the one fingerprint image is an incomplete pattern. In this instance, the processing unit 212 may associate the one fingerprint image with the incomplete pattern as the pattern type.

Subsequently, the processing unit 212 sets the central axis on the basis of the pattern type associated with the one fingerprint image and the one fingerprint image (step S502). When a plurality of pattern types are associated with the one fingerprint image, the processing unit 212 may set a plurality of central axes respectively corresponding to the plurality of pattern types, in the step S502.

The above operation may be realized by the information processing apparatus 2 reading a computer program recorded on a recording medium. In this case, it can be said that a computer program that allows the information processing apparatus 2 to perform the above operation is recorded on a recording medium.

In the information processing apparatus 2, the central axis is set for each pattern type associated with one fingerprint image. A person who registers fingerprints is able to register the central axis for each pattern type, for the one fingerprint image, with reference to the central axis set in the information processing apparatus 2. When the fingerprints indicated by the one fingerprint image are interpretable to be of a plurality of pattern types, a plurality of central axes may be registered for the one fingerprint image. According to the sixth example embodiment, for example, it is possible to support the fingerprint registration work. For example, when the plurality of central axes are registered for the one fingerprint image in a case where the fingerprints indicated by the one fingerprint image are interpretable to be of a plurality of pattern types, it is possible to prevent verification errors in the fingerprint verification using the one fingerprint image.

### Modified Example

The processing unit 212 may register one fingerprint image, the pattern type associated with the one fingerprint image, and the central axis corresponding to the pattern type, in place of or in addition to outputting a signal indicating the pattern type associated with the one fingerprint image and the central axis corresponding to the pattern type. In this instance, the processing unit 212 may perform the fingerprint verification on the one fingerprint image on the basis of the registered central axis. When the plurality of central axes are registered for the one fingerprint image, the processing unit 212 may perform the fingerprint verification on the one fingerprint image on the basis of each of the plurality of central axes.

### Seventh Example Embodiment

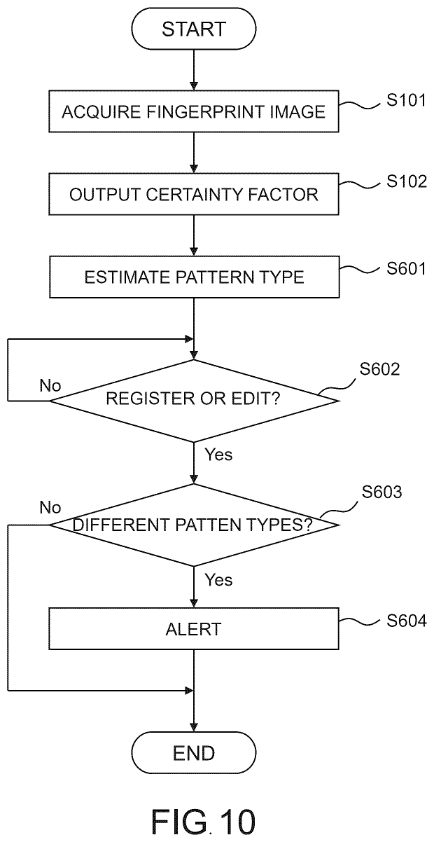

A fingerprint information processing apparatus, a fingerprint information processing method, and a recording medium according to a seventh example embodiment will be described with reference to FIG. 2 and FIG. 10. The following describes the fingerprint information processing apparatus, the fingerprint information processing method, and the recording medium according to the seventh example embodiment, by using the information processing apparatus 2. Here describes an example in which the information processing apparatus 2 is applied to the fingerprint registration work and an editing work. The seventh example embodiment mainly describes processing performed by the processing unit 212 (i.e., the processing based on the certainty factor). Other points according to the seventh example embodiment may be the same as those of the second to sixth example embodiments.

For example, in the fingerprint database managed by a public institution, fingerprint data may be registered in the following procedure. For example, an expert/person with special knowledge such as a fingerprint expert determines the pattern type of the fingerprints indicated by one fingerprint image. The one fingerprint image and the determined pattern type are registered as the fingerprint data associated with the one fingerprint image.

In the fingerprint database, it is possible to edit the registered fingerprint database. Therefore, when one fingerprint image is newly registered, first, only the one fingerprint image may be registered in the fingerprint database. Thereafter, when the pattern type of the fingerprints indicated by the one fingerprint image is determined, the determined pattern type may be added (registered) by editing the fingerprint data relating to the one fingerprint image.

The information processing apparatus 2 may perform the following operation to support at least one of the fingerprint registration work and the editing work, for example. Here, it is assumed that the fingerprint database is constructed in the storage apparatus 22 of the information processing apparatus 2.

The output unit 211 of the arithmetic apparatus 21 acquires one fingerprint image as the newly collected fingerprint image. The output unit 211 acquires the certainty factor relating to the one fingerprint image by inputting the one fingerprint image to the learning model. In this instance, the output unit 211 may acquire the plurality of certainty factors respectively corresponding to the plurality of pattern types, for the one fingerprint image. The output unit 211 transmits a signal indicating the certainty factor relating to the one fingerprint image, to the processing unit 212 of the arithmetic apparatus 21.

The processing unit 212 compares the certainty factor relating to the one fingerprint image, with the first predetermined value (see the second example embodiment). The processing unit 212 estimates the pattern type of the fingerprints indicated by the one fingerprint image, on the basis of the comparison result between each of the plurality of certainty factors respectively corresponding to the plurality of pattern types and the first predetermined value.

For the one fingerprint image, when the certainty factor that is higher than the first predetermined value is included in the plurality of certainty factors respectively corresponding to the plurality of pattern types, the processing unit 212 estimates that the pattern type of the fingerprints indicated by the one fingerprint image is the pattern type corresponding to the certainty factor that is higher than the first predetermined value. In this instance, the processing unit 212 associates the one fingerprint image with the pattern type corresponding to the certainty factor that is higher than the first predetermined value. When the plurality of certainty factors respectively associated with the plurality of pattern types are higher than the first predetermined value, the processing unit 212 may associate the one fingerprint image with the plurality of pattern types.

When the certainty factor that is higher than the first predetermined value is not included in the plurality of certainty factors respectively corresponding to the plurality of pattern types, the processing unit 212 may estimate that the pattern type of the fingerprints indicated by the one fingerprint image is an incomplete pattern. In this instance, the processing unit 212 may associate the one fingerprint image with the incomplete pattern as the pattern type.

When the pattern type associated with the one fingerprint image is registered or edited, for example, through the input apparatus 24 (in other words, when the user of the information processing apparatus 2 registers or edits the pattern type associated with the one fingerprint image), the processing unit 212 determines whether or not the registered or edited pattern type is the same as the pattern type associated by the processing unit 212 with the one fingerprint image. When the registered or edited pattern type is different from the pattern type associated by the processing unit 212 with the one fingerprint image, the processing unit 212 alert the user to encourage him to reconfirm the pattern type, for example. For example, when the input apparatus 24 receives information indicating registration or editing of the pattern type (e.g., information indicating that a button indicating “registration” or “update” is pressed), the processing unit 212 may determine that the pattern type is registered or edited.

When the registered or added pattern type is different from the pattern type associated by the processing unit 212 with the one fingerprint image, the processing unit 212 may determine whether or not the certainty factor corresponding to the pattern type associated by the processing unit 212 with the one fingerprint image is higher than the second predetermined value (see the fourth example embodiment). When the certainty factor is higher than the second predetermined value, the processing unit 212 may alert the user to encourage him to reconfirm the pattern type, for example. On the other hand, when the certainty factor is lower than the second predetermined value, the processing unit 212 may not alert the user. A case where the certainty factor is equal to the second predetermined value, may be included and treated in one of the two cases.

With reference to a flowchart in FIG. 10, the operation of the information processing apparatus 2 will be described. In FIG. 10, the output unit 211 of the arithmetic apparatus 21 acquires one fingerprint image (step S101). The output unit 211 acquires the certainty factor relating to the one fingerprint image by inputting the one fingerprint image to the learning model. The output unit 211 outputs the certainty factor relating to the one fingerprint image (step S102).

The processing unit 212 of the arithmetic apparatus 21 compares each of the plurality of certainty factors respectively corresponding to the plurality of pattern types, with the first predetermined value, on the basis of the certainty factor relating to the one fingerprint image. The processing unit 212 estimates the patten type of the fingerprints indicated by the one fingerprint image, on the basis of the comparison result between each of the plurality of certainty factors respectively corresponding to the plurality of pattern types and the first predetermined value (step S601).

In the step S601, for the one fingerprint image, when the certainty factor that is higher than the first predetermined value is included in the plurality of certainty factors respectively corresponding to the plurality of pattern types, the processing unit 212 estimates that the pattern type of the fingerprints indicated by the one fingerprint image is the pattern type corresponding to the certainty factor that is higher than the first predetermined value. In this instance, the processing unit 212 associates the one fingerprint image with the pattern type corresponding to the certainty factor that is higher than the first predetermined value. When the plurality of certainty factors respectively associated with the plurality of pattern types are higher than the first predetermined value, the processing unit 212 may associate the one fingerprint image with the plurality of pattern types. When the certainty factor that is higher than the first predetermined value is not included in the plurality of certainty factors respectively corresponding to the plurality of pattern types, the processing unit 212 may estimate that the pattern type of the fingerprints indicated by the one fingerprint image is an incomplete pattern. In this instance, the processing unit 212 may associate the one fingerprint image with the incomplete pattern as the pattern type.

The processing unit 212 determines whether or not the pattern type relating to the one fingerprint image is registered or edited (step S602). In the step S602, when it is determined that the pattern type is not registered nor edited (the step S602: No), the processing unit 212 performs the step S602 again. That is, the processing unit 212 may be in a standby state until the pattern type is registered or edited.

In the step S602, when it is determined that the pattern type is registered or edited (the step S602: Yes), the processing unit 212 determines whether or not the registered or edited pattern type is the same as the pattern type associated by the processing unit 212 with the one fingerprint image (step S603). In the step S603, when it is determined that the registered or edited pattern type is the same as the pattern type associated by the processing unit 212 with the one fingerprint image (the step S603: Yes), the operation illustrated in FIG. 10 is ended.

In the step S603, when it is determined that t the registered or edited pattern type is not the same as the pattern type associated by the processing unit 212 with the one fingerprint image (the step S603: No), the processing unit 212 alerts the user to encourage him to reconfirm the pattern type, for example (step S604).

In the step S604, the processing unit 212 may determine whether or not the certainty factor corresponding to the pattern type associated by the processing unit 212 with the one fingerprint image is higher than the second predetermined value. When the certainty factor is higher than the second predetermined value, the processing unit 212 may alert the user to encourage him to reconfirm the pattern type, for example. On the other hand, when the certainty factor is lower than the second predetermined value, the processing unit 212 may not alert the user.

The above operation may be realized by the information processing apparatus 2 reading a computer program recorded on a recording medium. In this case, it can be said that a computer program that allows the information processing apparatus 2 to perform the above operation is recorded on a recording medium.

According to the seventh example embodiment, for example, since the user is alerted to encourage him to reconfirm the pattern type, it is possible to prevent registration errors of the pattern type in the registration or editing of the fingerprint data.

### Eighth Example Embodiment

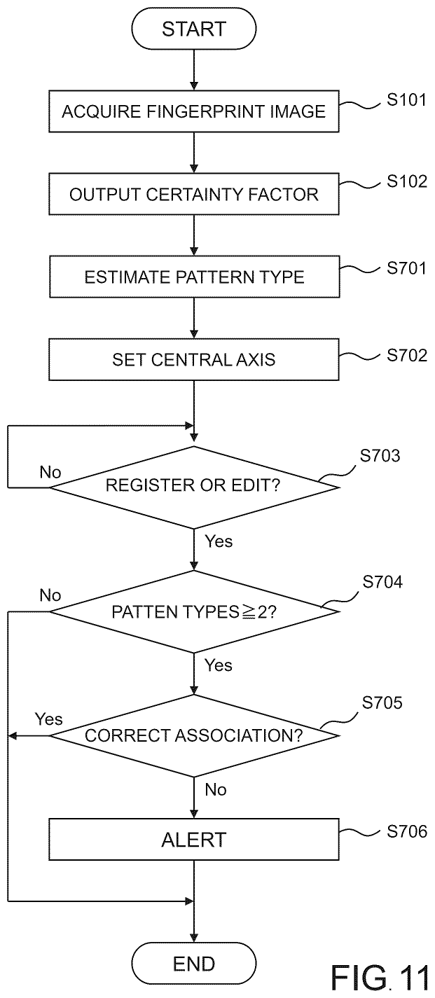

A fingerprint information processing apparatus, a fingerprint information processing method, and a recording medium according to an eighth example embodiment will be described with reference to FIG. 2 and FIG. 11. The following describes the fingerprint information processing apparatus, the fingerprint information processing method, and the recording medium according to the eighth example embodiment, by using the information processing apparatus 2. Here describes an example in which the information processing apparatus 2 is applied to the fingerprint registration work and the editing work. The eighth example embodiment mainly describes processing performed by the processing unit 212 (i.e., the processing based on the certainty factor). Other points according to the seventh example embodiment may be the same as those of the second to seventh example embodiments.

For example, in the fingerprint database managed by a public institution, fingerprint data may be registered in the following procedure. For example, an expert/person with special knowledge such as a fingerprint expert determines the pattern type of the fingerprints indicated by one fingerprint image. A person different from the person who determines the pattern type, determines the central axis of the fingerprints indicated by the one fingerprint image. The one fingerprint image, the determined pattern type, and the determined central axis are registered as the fingerprint data associated with the one fingerprint image.

In the fingerprint database, it is possible to edit the registered fingerprint database. Therefore, when one fingerprint image is newly registered, first, only the one fingerprint image may be registered in the fingerprint database. Thereafter, when the pattern type of the fingerprints indicated by the one fingerprint image is determined, the determined pattern type may be added (registered) by editing the fingerprint data relating to the one fingerprint image. Similarly, when the central axis of the fingerprints indicated by the one fingerprint image is determined, the determined central axis may be added (registered) by editing the fingerprint data relating to the one fingerprint image.

As described in the sixth example embodiment, the direction in which the central axis extends, often varies depending on the pattern type. When the fingerprints indicated by the one fingerprint image are interpretable to be of a plurality of pattern types, a plurality of central axes respectively corresponding to the plurality of pattern types may be registered for the one fingerprint image. As described above, the person who determines the pattern type may be different from the person who determines the central axis. Thus, for example, one of the plurality of pattern types may be registered in association with the central axis that does not correspond to the one pattern type. In that case, there is an error in the central axis associated with the one pattern type. Therefore, there is a possibility that the fingerprint verification is not properly performed on the one fingerprint image.

For example, in a case where two central axes are registered for one fingerprint image, when the one fingerprint image is collated/verified with a verification target limited on the basis of one pattern type associated with the one fingerprint image without consideration of a correlation between the pattern type and the central axis, it is conceivable to perform both the fingerprint verification in a verification range limited by one of the two central axes and the fingerprint verification in a verification range limited by the other central axis. With this configuration, it is possible to properly perform the fingerprint verification on the one fingerprint image. However, a processing load relating to the fingerprint verification is increased, for example.

The information processing apparatus 2 may perform the following operation to support at least one of the fingerprint registration work and the editing work, for example. Here, it is assumed that the fingerprint database is constructed in the storage apparatus 22 of the information processing apparatus 2.

The output unit 211 of the arithmetic apparatus 21 acquires one fingerprint image. The output unit 211 acquires the certainty factor of the one fingerprint image by inputting the one fingerprint image to the learning model. In this instance, the output unit 211 may acquire the plurality of certainty factors respectively corresponding to the plurality of pattern types, for the one fingerprint image. The output unit 211 transmits a signal indicating the certainty factor relating to the one fingerprint image, to the processing unit 212 of the arithmetic apparatus 21.

The processing unit 212 compares the certainty factor relating to the one fingerprint image, with the first predetermined value (see the second example embodiment). The processing unit 212 estimates the pattern type of the fingerprints indicated by the one fingerprint image, on the basis of the comparison result between each of the plurality of certainty factors respectively corresponding to the plurality of pattern types and the first predetermined value.

For the one fingerprint image, when the certainty factor that is higher than the first predetermined value is included in the plurality of certainty factors respectively corresponding to the plurality of pattern types, the processing unit 212 estimates that the pattern type of the fingerprints indicated by the one fingerprint image is the pattern type corresponding to the certainty factor that is higher than the first predetermined value. In this instance, the processing unit 212 associates the one fingerprint image with the pattern type corresponding to the certainty factor that is higher than the first predetermined value. When the plurality of certainty factors respectively associated with the plurality of pattern types are higher than the first predetermined value, the processing unit 212 may associate the one fingerprint image with the plurality of pattern types.

When the certainty factor that is higher than the first predetermined value is not included in the plurality of certainty factors respectively corresponding to the plurality of pattern types, the processing unit 212 may estimate that the pattern type of the fingerprints indicated by the one fingerprint image is an incomplete pattern. In this instance, the processing unit 212 may associate the one fingerprint image with the incomplete pattern as the pattern type.

The processing unit 212 sets the central axis on the basis of the pattern type associated with the one fingerprint image and the one fingerprint image. When a plurality of pattern types are associated with the one fingerprint image, the processing unit 212 may set a plurality of central axes respectively corresponding to the plurality of pattern types. That is, the processing unit 212 may set one central axis for each pattern type associated with the one fingerprint image.

When the plurality of pattern types and the plurality of central axes are registered or edited for the one fingerprint image, for example, through the input apparatus 24 (in other words, when the user of the information processing apparatus 2 registers or edits the plurality of pattern types and the plurality of central axes for the one fingerprint image), the processing unit 212 determines whether or not the plurality of central axes respectively associated with the plurality of pattern types are correct. In this instance, the processing unit 212 may compare the central axis associated with one pattern type, with the central axis is set by the processing unit 212 for the one pattern type, for example. The processing unit 212 may determine whether or not the plurality of central axes respectively associated with the plurality of pattern types are correct on the basis of a comparison result. When it is determined that the central axis associated with at least one of the plurality of pattern types is not correct, the processing unit 212 alerts the user to encourage him to reconfirm the central axis, for example.

It is assumed that the registered or edited pattern type relating to the one fingerprint image is the same as the pattern type associated by the processing unit 212 with the one fingerprint image on the basis of the certainty factor. If the registered or edited pattern type relating to the one fingerprint image is different from the pattern type associated by the processing unit 212 with the one fingerprint image on the basis of the certainty factor, as described in the seventh example embodiment, the processing unit 212 may alert the user to encourage him to reconfirm the pattern type, for example.

With reference to a flowchart in FIG. 11, the operation of the information processing apparatus 2 will be described. In FIG. 11, the output unit 211 of the arithmetic apparatus 21 acquires one fingerprint image (step S101). The output unit 211 acquires the certainty factor relating to the one fingerprint image by inputting the one fingerprint image to the learning model. The output unit 211 outputs the certainty factor relating to the one fingerprint image (step S102).

The processing unit 212 of the arithmetic apparatus 21 compares each of the plurality of certainty factors respectively corresponding to the plurality of pattern types, with the first predetermined value, on the basis of the certainty factor relating to the one fingerprint image. The processing unit 212 estimates the pattern type of the fingerprints indicated by the one fingerprint image on the basis of the comparison between each of the plurality of certainty factors respectively corresponding to the plurality of pattern types and the first predetermined value (step S701).

In the step S701, for the one fingerprint image, when the certainty factor that is higher than the first predetermined value is included in the plurality of certainty factors respectively corresponding to the plurality of pattern types, the processing unit 212 estimates that the pattern type of the fingerprints indicated by the one fingerprint image is the pattern type corresponding to the certainty factor that is higher than the first predetermined value. In this instance, the processing unit 212 associates the one fingerprint image with the pattern type corresponding to the certainty factor that is higher than the first predetermined value. When the plurality of certainty factors respectively associated with the plurality of pattern types are higher than the first predetermined value, the processing unit 212 may associate the one fingerprint image with the plurality of pattern types. When the certainty factor that is higher than the first predetermined value is not included in the plurality of certainty factors respectively corresponding to the plurality of pattern types, the processing unit 212 may estimate that the pattern type of the fingerprints indicated by the one fingerprint image is an incomplete pattern. In this instance, the processing unit 212 may associate the one fingerprint image with the incomplete pattern as the pattern type.

Subsequently, the processing unit 212 sets the central axis on the basis of the pattern type associated with the one fingerprint image and the one fingerprint image (step S702). When a plurality of pattern types are associated with the one fingerprint image, the processing unit 212 may set a plurality of central axes respectively corresponding to the plurality of pattern types, in the step S702.

The processing unit 212 determines whether or not at least one of the pattern type and the central axis is registered or edited for the one fingerprint image (step S703). In the step S703, when it is determined that the pattern type and the central axis is not registered nor edited (the step S703: No), the processing unit 212 performs the step S703 again. That is, the processing unit 212 may be in a standby state until at least one of the pattern type and the central axis is registered or edited.

In the step S703, when it is determined that at least one of the pattern type and the central axis is registered or edited (the step S703: Yes), the processing unit 212 determines whether or not there are two or more pattern types associated with the one fingerprint image (step S704). In the step S704, when it is determined that there are not two or more pattern types (the step S704: No), the operation illustrated in FIG. 11 is ended.

In the step S704, when it is determined that there are two or more pattern types (the step S704: Yes), the processing unit 212 determines whether or not the plurality of central axes respectively associated with the plurality of pattern types are correct (step S705). In the step S705, when it is determined that the plurality of central axes respectively associated with the plurality of pattern types are correct (the step S705: Yes), the operation illustrated in FIG. 11 is ended.

In the step S705, when it is determined that the plurality of central axes respectively associated with the plurality of pattern types are not correct (the step S705: No), the processing unit 212 alerts the user to encourage him to reconfirm the central axis, for example (step S706).

The above operation may be realized by the information processing apparatus 2 reading a computer program recorded on a recording medium. In this case, it can be said that a computer program that allows the information processing apparatus 2 to perform the above operation is recorded on a recording medium.

According to the eighth example embodiment, for example, since the user is alerted to encourage him to reconfirm the central axis associated with the pattern type, it is possible to prevent registration errors of the central axis in the registration or editing of the fingerprint data. In the fingerprint database, the central axis is associated with the pattern type. For example, in a case where two pattern types and two central axes respectively associated with the two pattern types are registered for one fingerprint image, the fingerprint verification for the one fingerprint image is performed as follows. When the one fingerprint image is collated/verified with a verification target limited on the basis of one of the two pattern types, a verification range is limited by the central axis associated with the one pattern type, and the fingerprint verification is then performed. Furthermore, when the one fingerprint image is collated/verified with a verification target limited on the basis of the other of the two pattern types, the verification range is limited by the central axis associated with the other pattern type, and the fingerprint verification is then performed. It is therefore possible to properly perform the fingerprint verification on the one fingerprint processing, without increasing the processing load relating to the fingerprint verification

### Modified Example

The processing unit 212 may register the plurality of pattern types associated with the one fingerprint image in the step S701 and the plurality of central axes respectively corresponding to the plurality of pattern types set in the step S702, in the fingerprint database, in association with each other, in place of or in addition to alerting the user to encourage him to reconfirm the central axis in the step 706, for example.

### <Supplementary Notes>

With respect to the example embodiment described above, the following Supplementary Notes are further disclosed.

### (Supplementary Note 1)

A fingerprint information processing apparatus including:
an output unit that outputs a certainty factor that is an index indicating probability in which fingerprints indicated by a fingerprint image correspond to at least one of a plurality of pattern types, by using the fingerprint image and a learning model constructed by machine learning using learning data including a sample image indicating fingerprints; and
a processing unit that performs processing based on the certainty factor.

### (Supplementary Note 2)

The fingerprint information processing apparatus according to Supplementary Note 1, wherein
the output unit outputs the certainty factor by combining an output result of a first model when the fingerprint image is inputted to the first model serving as the learning model and an output result of a second model when the fingerprint image is inputted to the second model serving as the learning model, and
the first model and the second model different output tendencies to an input.

### (Supplementary Note 3)

The fingerprint information processing apparatus according to Supplementary Note 1 or 2, wherein
the output unit outputs the certainty factor by using already registered one fingerprint image serving as the fingerprint image and the learning model, and
the processing unit, as the processing,
estimates a pattern type of fingerprints indicated by the one fingerprint image on the basis of the certainty factor, and
performs at least one of giving notice and updating of a pattern type already associated with the one fingerprint image, when the estimated pattern type is different from the pattern type already associated with the one fingerprint image.

### (Supplementary Note 4)

The fingerprint information processing apparatus according to any one of Supplementary Notes 1 to 3, wherein
the processing unit, as the processing,
estimates a pattern type of the fingerprints indicated by the fingerprint image on the basis of the certainty factor, and
sets a plurality of central axes respectively corresponding to two or more pattern types, when the fingerprints indicated by the fingerprint image correspond to the two or more pattern types out of the plurality of pattern types.

### (Supplementary Note 5)

The fingerprint information processing apparatus according to Supplementary Note 4, wherein when the two or more pattern types include an arch pattern and one pattern type that is different from the arch pattern, the processing unit sets a central axis extending in a fingertip direction of the fingerprints indicated by the fingerprint image, as a central axis corresponding to the arcuate pattern, and sets a central axis extending in a direction of core recurve of the fingerprints indicated by the fingerprint image, as a central axis corresponding to the one pattern type.

### (Supplementary Note 6)

The fingerprint information processing apparatus according to Supplementary Note 4 or 5, wherein the processing unit performs fingerprint verification on the fingerprint image, by using each of the plurality of central axes respectively corresponding to the two or more pattern types, as the processing.

### (Supplementary Note 7)

The fingerprint information processing apparatus according to any one of Supplementary Notes 1 to 6, wherein
the processing unit, as the processing,
estimates a pattern type of the fingerprints indicated by the fingerprint image on the basis of the certainty factor, and
gives notice when a pattern type inputted by a user for the fingerprints indicated by the fingerprint image is different from the estimated pattern type.

### (Supplementary Note 8)

The fingerprint information processing apparatus according to any one of Supplementary Notes 1 to 7, wherein
the processing unit, as the processing,
estimates a pattern type of the fingerprints indicated by the fingerprint image on the basis of the certainty factor,
sets a plurality of central axes respectively corresponding to two or more pattern types, when the fingerprints indicated by the fingerprint image correspond to the two or more pattern types out of the plurality of pattern types, and
gives notice when a correlation between the two or more pattern types and the plurality of set central axes is different from a correlation between a pattern type and a central axes, which is inputted by a user for the fingerprints indicated by the fingerprint image.

### (Supplementary Note 9)

A fingerprint information processing method including:
outputting a certainty factor that is an index indicating probability in which fingerprints indicated by a fingerprint image correspond to at least one of a plurality of pattern types, by using the fingerprint image and a learning model constructed by machine learning using learning data including a sample image indicating fingerprints; and
performing processing based on the certainty factor.

### (Supplementary Note 10)

A recording medium on which a computer program that allows a computer to execute a fingerprint information processing method is recorded, the fingerprint information processing method including:
outputting a certainty factor that is an index indicating probability in which fingerprints indicated by a fingerprint image correspond to at least one of a plurality of pattern types, by using the fingerprint image and a learning model constructed by machine learning using learning data including a sample image indicating fingerprints; and
performing processing based on the certainty factor.

This disclosure is not limited to the example embodiments described above. For example, when pattern classification is possible for a palmprint, this disclosure may be applied to the palmprint in addition to the fingerprint. This disclosure is allowed to be changed, if desired, without departing from the essence or spirit of this disclosure which can be read from the claims and the entire identification. A fingerprint information processing apparatus, a fingerprint information processing method, and a recording medium with such changes are also intended to be within the technical scope of this disclosure.

To the extent permitted by law, this application claims the benefit of priority based on Japanese application No. 2022-120344, filed Jul. 28, 2022, the entire disclosure of which is hereby incorporated by reference. Furthermore, to the extent permitted by law, all publications and papers described herein are hereby incorporated by reference.

### DESCRIPTION OF REFERENCE CODES

1, 2 Information processing apparatus
11, 211 Output unit
12, 212 Processing unit
21 Arithmetic apparatus
22 Storage apparatus
23 Communication apparatus
24 Input apparatus
25 Output apparatus

What is claimed is:

1. A fingerprint information processing apparatus comprising:
at least one memory that is configured to store instructions; and
at least one processor that is configured to execute the instructions to:
output a certainty factor that is an index indicating probability in which fingerprints indicated by a fingerprint image correspond to at least one of a plurality of pattern types, by using the fingerprint image and a learning model constructed by machine learning using learning data including a sample image indicating fingerprints; and
perform processing based on the certainty factor.

2. The fingerprint information processing apparatus according to claim 1, wherein
the at least one processor that is configured to execute the instructions to output the certainty factor by combining an output result of a first model when the fingerprint image is inputted to the first model serving as the learning model and an output result of a second model when the fingerprint image is inputted to the second model serving as the learning model, and
the first model and the second model different output tendencies to an input.

3. The fingerprint information processing apparatus according to claim 1, wherein the at least one processor that is configured to execute the instructions to
output the certainty factor by using already registered one fingerprint image serving as the fingerprint image and the learning model, and,
as the processing,
estimate a pattern type of fingerprints indicated by the one fingerprint image on the basis of the certainty factor, and
perform at least one of giving notice and updating of a pattern type already associated with the one fingerprint image, when the estimated pattern type is different from the pattern type already associated with the one fingerprint image.

4. The fingerprint information processing apparatus according to claim 1, wherein the at least one processor that is configured to execute the instructions to,
as the processing,
estimate a pattern type of the fingerprints indicated by the fingerprint image on the basis of the certainty factor, and
set a plurality of central axes respectively corresponding to two or more pattern types, when the fingerprints indicated by the fingerprint image correspond to the two or more pattern types out of the plurality of pattern types.

5. The fingerprint information processing apparatus according to claim 4, wherein when the two or more pattern types include an arch pattern and one pattern type that is different from the arch pattern, the at least one processor that is configured to execute the instructions to set a central axis extending in a fingertip direction of the fingerprints indicated by the fingerprint image, as a central axis corresponding to the arcuate pattern, and set a central axis extending in a direction of core recurve of the fingerprints indicated by the fingerprint image, as a central axis corresponding to the one pattern type.

6. The fingerprint information processing apparatus according to claim 4, wherein the at least one processor that is configured to execute the instructions to perform fingerprint verification on the fingerprint image, by using each of the plurality of central axes respectively corresponding to the two or more pattern types, as the processing.

7. The fingerprint information processing apparatus according to claim 1, wherein the at least one processor that is configured to execute the instructions to,
as the processing,
estimate a pattern type of the fingerprints indicated by the fingerprint image on the basis of the certainty factor, and
give notice when a pattern type inputted by a user for the fingerprints indicated by the fingerprint image is different from the estimated pattern type.

8. The fingerprint information processing apparatus according to claim 1, wherein the at least one processor that is configured to execute the instructions to,
as the processing,
estimate a pattern type of the fingerprints indicated by the fingerprint image on the basis of the certainty factor,
set a plurality of central axes respectively corresponding to two or more pattern types, when the fingerprints indicated by the fingerprint image correspond to the two or more pattern types out of the plurality of pattern types, and
give notice when a correlation between the two or more pattern types and the plurality of set central axes is different from a correlation between a pattern type and a central axis, which is inputted by a user for the fingerprints indicated by the fingerprint image.

9. A fingerprint information processing method comprising:
outputting a certainty factor that is an index indicating probability in which fingerprints indicated by a fingerprint image correspond to at least one of a plurality of pattern types, by using the fingerprint image and a learning model constructed by machine learning using learning data including a sample image indicating fingerprints; and
performing processing based on the certainty factor.

10. A non-transitory recording medium on which a computer program that allows a computer to execute a fingerprint information processing method is recorded, the fingerprint information processing method including:
outputting a certainty factor that is an index indicating probability in which fingerprints indicated by a fingerprint image correspond to at least one of a plurality of pattern types, by using the fingerprint image and a learning model constructed by machine learning using learning data including a sample image indicating fingerprints; and
performing processing based on the certainty factor.
